(19) United States
(12) Patent Application Publication
(10) Pub. No.: US 2026/0065942 A1
(43) Pub. Date: Mar. 5, 2026

(54) ENHANCING SHORT FORM VIDEO CREATION TOOL OF A CONTENT PLATFORM

(71) Applicant: Google LLC, Mountain View, CA (US)

(72) Inventors: Karthika Periyathambi, Mountain View, CA (US); Danielle Darby, Brisbane, CA (US); Vadim Lavrusik, Half Moon Bay, CA (US); Todd Sherman, Burlingame, CA (US); Cameron T. Luck, Pflugerville, TX (US); Jiasheng Yang, Mountain View, CA (US); Xinyu Xiao, San Jose, CA (US); Priyanka Vijay Hubli, Sunnyvale, CA (US); Ronnel Patrick Boettcher, Emeryville, CA (US); Xi Han, Foster City, CA (US); Gengrui Wei, Sunnyvale, CA (US); Zhen Chui, Cupertino, CA (US); Juliana Azniv Glodek, Belmont, CA (US); Munir Rajesh Mehta, Union City, CA (US); Janelle Wen, San Bruno, CA (US); Juan Luis Flores Mena, San Francisco, CA (US); Ryan Thomas McDermott, Oakland, CA (US)

(21) Appl. No.: 18/819,250

(22) Filed: Aug. 29, 2024

(51) Int. Cl. G11B 27/036; G06F 3/0481; G06F 3/0484; G06V 20/40; G11B 27/34; H04N 5/91

(52) U.S. Cl. CPC G11B 27/036; G06F 3/0481; G06F 3/0484; G11B 27/34; H04N 5/91; G06V 20/46

(57) ABSTRACT

A system and methods are disclosed for enhancing short form video creation tool of a content platform. The method includes obtaining a feature template of a first video item, the feature template identifying a plurality of features of the first video item, receiving a user request to create a second video item based on the first video item, in response to the user request, presenting, in a video creation user interface (UI), one or more feature representation placeholders each associated with a feature of the plurality of features identified by the feature template of the first video item, while the second video item is being recorded, receiving user input with respect to at least one feature representation placeholder of the one or more feature representation placeholders, and causing at least one feature corresponding to the at least one feature representation placeholder to be reflected in the second video item.

### TECHNICAL FIELD

Aspects and implementations of the present disclosure relate to methods and systems for enhancing a short form video creation tool of a content platform.

### BACKGROUND

A platform (e.g., a content sharing platform, etc.) can provide (e.g., stream) video items, such as short form videos, to client devices connected to the platform via a network. The platform includes a short form video creation tool that allows video creators to create short form videos to be accessible to other client devices connected to the platform for consumption by end users.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for enhancing a short form video creation tool of a content platform. A feature template of a first video item, the feature template identifying a plurality of features of the first video item is obtained. A user request is received to create a second video item based on the first video item. In response to the user request, one or more feature representation placeholders each associated with a feature of the plurality of features identified by the feature template of the first video item is presented in a video creation user interface (UI). While the second video item is being recorded, user input is received with respect to at least one feature representation placeholder of the one or more feature representation placeholders. At least one feature corresponding to the at least one feature representation placeholder is caused to be reflected in the second video item.

In some implementations, the plurality of features includes at least one of: an audio of the first video item, a text of the first video item, a segment characteristic of the first video item, or a visual effect of the first video item.

In some implementations, each of the one or more feature representation placeholders comprises attributes of a corresponding feature.

In some implementations, the attributes of a feature comprise an identifier of the feature, a constraint of the feature, a designated location for the feature, and information to be displayed about the feature.

In some implementations, the video creation UI presents a thumbnail of the first video item along with the one or more feature representation placeholders.

In some implementations, a video clip associated with the second video item is recorded for a duration associated with the at least one feature representation placeholder and the corresponding at least one feature is added to the recorded video clip.

In some implementations, the recorded video clip with the corresponding at least one feature to be inherited from the first video item is presented and a user is allowed to modify the corresponding at least one feature for the recorded video clip.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2A illustrates an example content viewer UI displaying an existing short form video with a reuse UI element triggering a reuse of features of the existing short form video for a new short form video, in accordance with implementations of the present disclosure.

FIG. 2B illustrates an example content viewer UI displaying an existing short form video with UI elements representing features of the existing short form video that can be inherited by a new short form video, in accordance with implementations of the present disclosure.

FIG. 3 illustrates an example UI to visually indicate features of an existing short form video that may be inherited by a new short form video, in accordance with implementations of the present disclosure.

FIG. 4 depicts a flow diagram illustrating an example method for enhancing a short form video creation tool, in accordance with implementations of the present disclosure.

FIG. 5 is a block diagram illustrating an exemplary computer system, in accordance with implementations of the present disclosure.

### DETAILED DESCRIPTION OF THE DRAWINGS

Aspects of the present disclosure relate to enhancing a short form video creation tool of a content platform. The content platform can enable a content creator to upload a video item (e.g., a short form video) for consumption by another user of the content platform. Short form videos (e.g., shorts) are a type of video content with a concise format, typically lasting up to 60 seconds. These can be created using a video creation tool of the content platform that provides users with various functionalities to enhance their shorts, such as multi-segment camera recording, filters, music library, text editing, etc. Multi-segment camera recording allows users to record their short in segments, like bite-sized clips. This provides users flexibility in previewing individual segments before moving on, re-recording segments with mistakes without starting over, and rearranging the segments for a more polished final short. Filters refer to a collection of pre-set filters available within the video creation tool. These filters can be used to modify the color and/or lighting of the entire short or just one or more segments of the video. The music library refers to a collection of audio tracks that users can select and customize. This customization can involve trimming or editing the music to fit the video and then overlaying it over the entire short or specific segments. Text editing provides users with the ability to add captions, titles, and other text overlays. These text elements can be added to the entire short or specific segments. By utilizing these functionalities, users can create engaging and informative short content.

For example, a first user, such as the content creator, can create a short (via the video creation tool) and provide (e.g., upload) the short to the content platform to be available to other users. A second user of the content platform can access the short provided by the first user via a user interface (UI) provided by the content platform at a client device associated with the second user. The UI of the content platform can allow the second user to engage with the short of the first user. For example, the second user may indicate their attitude towards the short (e.g., like or dislike), their thoughts towards the short (e.g., comments), or share the short with others.

The second user may wish to create their own short using audio or filters from the short of the first user. To create their own short, the second user can utilize the video creation tool to include the audio and/or filter from the short of the first user into their own short, which can be referred to as a remix of the short of the first user. In some instances, the second user may wish to replicate an overall style of the short of the first user. However, in order to mimic the overall style of the short of the first user, the second user typically needs to visually inspect the stylistic features of the short of the first user and manually incorporate them to their short. As a result, creating a remix short that replicates the stylistic features of another short can be time consuming and can result in an inferior replica.

Aspects of the present disclosure address the above and other deficiencies by enhancing a video creation tool based on a feature template, generated using the stylistic features of an original short, to allow a video creator to repurpose features of the original short when creating a new short. A feature template can include a plurality of feature representation placeholders each corresponding to a UI element that displays information about a specific feature of the original short. Features of the original short can include, for example, a segment characteristic feature, a filter feature, an audio features, or a text feature. A segment characteristic feature can refer to segment related characteristics (e.g., duration or ordering of segments) of the original short. A filter feature can refer to a visual effect included in the original short. An audio feature can refer to an audio included in the original short. A text feature can refer to a caption, title, or overlay included in the original short. Feature templates can be generated for each short upon upload, or periodically using a database of shorts. In some embodiments, feature templates are generated based on metadata generated by the video creation tool during creation of the original short. In some embodiments, the original short may be created externally. Accordingly, the original short can be analyzed for specific features that can be used to generate metadata which can be subsequently used to generate a feature template.

During playback of the original short, a user can be presented with an option to create a new short based on the original short. Responsive to a user request to create the new short based on the original short, a feature template associated with the original short can be presented in a video creation tool user interface (UI) for the user. In particular, the plurality of feature representation placeholders of the feature template can be presented in the video creation tool UI. The user may select a feature representation placeholder of the plurality of feature representation placeholders to cause the new short to inherit a corresponding feature of the original short. For example, if a feature representation placeholder corresponding to a segment characteristic feature of the original short is selected, one or more segment characteristics (e.g., segment duration, segment ordering, etc.) of the original short can be incorporated into the new short when one or more segments of the new short are being recorded. In some embodiments, one or more feature representation placeholder(s) corresponding to the segment characteristic(s) may be used for the newly recorded segment(s) in real-time during recording or after the recording is completed. If one or more additional feature representation placeholders are selected, respective additional features of the original short (e.g., audio, text, and/or filters) can be applied to corresponding segment(s) of the new short. The user may indicate that the new short is complete (e.g., all segments of the short has been recorded), and in response, the new short can be uploaded to be available to other users.

Accordingly, aspects of the present disclosure cover techniques that enable new shorts to automatically inherit stylistic (and optionally other) features of existing shorts, thus improving usability of existing shorts and efficiency of the short form video creation tool.

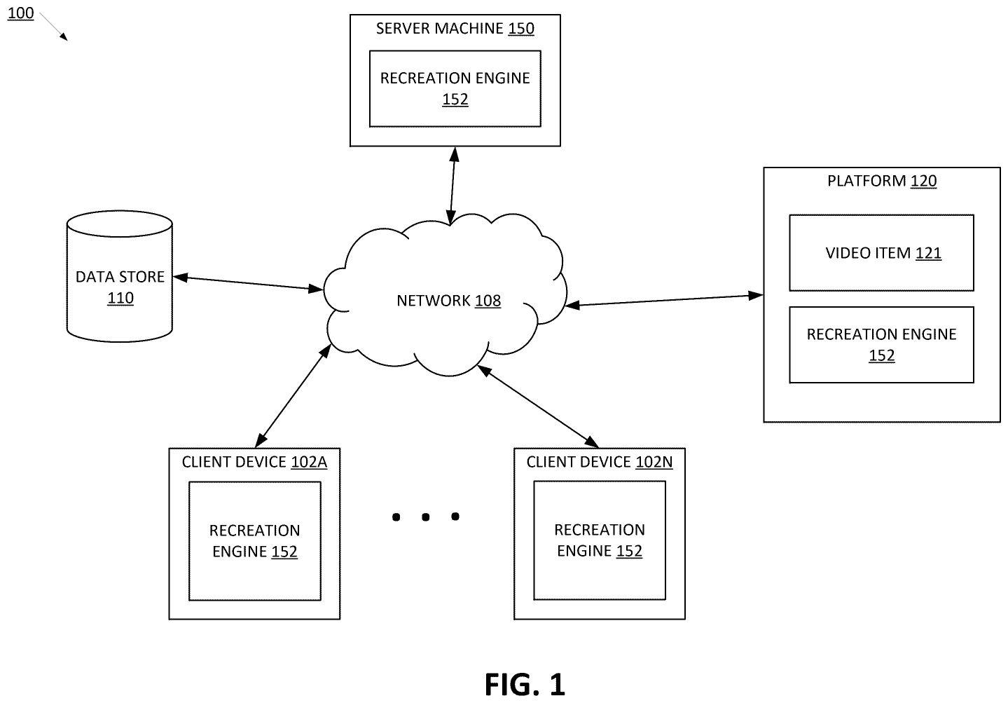

FIG. 1 illustrates an example system architecture 100, in accordance with implementations of the present disclosure. The system architecture 100 (also referred to as “system” herein) includes client devices 102A-N, a data store 110, a platform 120 (e.g., content platform), and/or a server machine 150, each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, platform 120 can be a content sharing platform that allows users to consume, upload, share, search for, approve of (“like”), dislike, and/or comment on video items 121. Platform 120 can include a website (e.g., a webpage) or application back-end software used to provide users access to video items 121 (e.g., via client devices 102A-N). A video item 121 can be consumed via a web browser or via a mobile device application, such as a content viewer (not shown) of client device 102A-N. In some embodiments, a video item 121 can correspond to a media file (e.g., a video file, and audio file, etc.). In other or similar embodiments, a video item 121 can correspond to a portion of a media file (e.g., a portion or a chunk of a video file, an audio file, etc.). As discussed previously, a video item 121 can be requested for presentation to users of the platform by a user of platform 120. As used herein, “media,” video item,” “online video item,” “digital media,” “digital video item,” “content,” and “content item” can include an electronic file that can be executed or loaded using software, firmware or hardware configured to present the digital video item to an entity. In one implementation, platform 120 can store the video items 121 using data store 110. In another implementation, platform 120 can store video item 121 or fingerprints as electronic files in one or more formats using data store 110. Platform 120 can provide video item 121 to a user associated with a client device (e.g., client device 102A) by allowing access to video item 121 (e.g., via a content sharing platform application), transmitting the video item 121 to the client device 102A, and/or presenting or permitting presentation of the video item 121 at a display device of client device 102A.

Video item 121 can refer to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments, data store 110 can be some other type of persistent storage such as an object-oriented database, a relational database, and so forth, that may be hosted by platform 120 or one or more different machines coupled to platform 120 via network 108. Data store 110 can include a media cache that stores copies of video items that are received from platform 120. In one example, video item 121 can be a file that is downloaded from platform 120 and can be stored locally in media cache. In another example, video item 121 can be streamed from platform 120 and can be stored as an ephemeral copy in memory of one or more of server machine 150.

The client devices 102A-N can each include computing devices such as personal computers (PCs), laptops, mobile phones, smartphones, tablet computers, netbook computers, network-connected televisions, virtual reality headset, etc. In some implementations, client devices 102A-N may also be referred to as “user devices.” Client devices 102A-N can include a content viewer. In some implementations, a content viewer can be an application that provides a user interface (UI) for users to view or upload content, such as images, videos, web pages, documents, etc. For example, the content viewer can be a web browser that can access, retrieve, present, and/or navigate content (e.g., web pages such as Hyper Text Markup Language (HTML) pages, digital videos, etc.) served by a web server. The content viewer can render, display, and/or present the content to a user. The content viewer can also include an embedded media player (e.g., a Flash® player or an HTML5 player) embedded in a web page (e.g., a web page that may provide information about a product sold by an online merchant). In another example, the content viewer can be a standalone application (e.g., a mobile application or app) that allows users to view digital videos (e.g., digital videos, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by platform 120.

Platform 120 can include multiple channels (e.g., channels A through Z). A channel can include one or more video items 121 available from a common source or video items 121 having a common topic, theme, or substance. Video item 121 can be digital content chosen by a user, digital content made available by a user, digital content uploaded by a user, digital content chosen by a content provider, digital content chosen by a broadcaster, etc. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” can also be referred to as “liking,” “following,” “friending,”and so on.

In some embodiments, system 100 can include one or more third party platforms (not shown). In some embodiments, a third party platform can provide other services associated with video items 121. For example, a third party platform can include an advertisement platform that can provide video and/or audio advertisements. In another example, a third party platform can be a video streaming service provider that provides a media streaming service via a communication application for users to play videos, TV shows, video clips, audio, audio clips, and movies, on client devices 102A-N via the third party platform.

In some embodiments, a client device (e.g., 102N) can transmit a request to platform 120 for access to a video item 121. Platform 120 can identify the video item 121 of the request (e.g., at data store 110, etc.) and can provide access to the video item 121 via the UIs of the content viewers provided by platform 120. In some embodiments, the requested video item 121 is generated by another client device 102A-N connected to platform 120. For example, client device 102A can generate a video item (e.g., via an audio-visual component, such as a camera, of client device 102A) and provide the generated video item to platform 120 (e.g., via network 108) to be accessible by other users of the platform. In other or similar embodiments, the requested video item 121 can have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102N, can transmit the request to platform 120 (e.g., via network 108) to access the video item provided by client device 102A, in accordance with the previously provided examples.

In some embodiments, video item 121 can be a short-form video item. A short-form video item refers to a video item 121 that has a duration that falls below a particular threshold duration (e.g., as defined by a developer or administrator of platform 120). In one example, a short-form video item can have a duration of 120 seconds or less. In another example, a short-form video item can have a duration of 60 seconds or less. In other or similar embodiments, a video item 121 can be a long-form video item. A long-form video item refers to a video item that has a longer duration than a short-form video item (e.g., several minutes, several hours, etc.). In some embodiments, a short-form video item may include visually or audibly rich or complex content for all or most of the video item duration, as a content creator has a smaller amount of time to capture the attention of users accessing the video item 121 and/or to convey a target message associated with the video item 121. In additional or similar embodiments, a long-form video item may also include visually or audibly rich or complex content, but such content may be distributed throughout the duration of the long-form video item, diluting the concentration of such content for the duration of the video item 121. As described above, data store 110 can store video items 121, which can include short-form video items and/or long-form video items, in some embodiments. In additional or alternative embodiments, data store 110 can store one or more long-form video items and can store an indication of one or more segments of the long-form video items that can be presented as short-form video items. It should be noted that although some embodiments of the present disclosure refer specifically to short-form video items, such embodiments can be applied to long-form video items, and vice versa. It should also be noted that embodiments of the present disclosure can additionally or alternatively be applied to live streamed media items (e.g., which may or may not be stored at data store 110).

As illustrated in FIG. 1, platform 120 can include a recreation engine 152. Depending on the embodiment, recreation engine 152 may be separate from platform 120 at server machine 150 or part of platform 120. In some embodiments, some or all components of recreation engine 152 may reside on client devices 102A-N.

Recreation engine 152 may generate a feature template for each video item. The feature template can include a plurality of feature representation placeholders. Each feature representation placeholder can be a temporary UI element that includes, for example, an identifier of the specific feature, constraints of the specific feature, a designated location for the specific feature, etc. When the feature representation placeholder is displayed, it can provide information about the specific feature of the video item. Features of the video item can include, for example, segment characteristic features, filter features, audio features, text features, etc.

Each feature representation placeholder can include a type of the corresponding feature, a constraint of the feature, and feature information to be displayed. For example, each feature representation placeholder corresponding to a segment characteristic feature can include a segment characteristic feature as the type, a segment duration (derived from a start time and stop time of the specific segment) as the constraint, and a visual representation of the segment duration as the feature information to be displayed. Each feature representation placeholder corresponding to a filter feature (referring to a filter applied to the video item or specific segments of the video item) can include filter feature as the type, an identifier of a specific filter in a collection of filters as the constraint, and a visual representation of the specific filter as feature information to be displayed. Each feature representation placeholder corresponding to an audio feature (referring to an audio of the video item or specific segments of the video item) can include audio feature as the type, an identifier of a specific audio track in a music library as the constraint, and a visual representation of the specific audio track as feature information to be displayed. Each text feature (referring to a caption, title, or overlay applied to the video item or specific segments of the video item) generates a feature representation placeholder corresponding to a text feature (referring to a caption, title, or overlay applied to the video item or specific segments of the video item) can include text feature as the type, string of characters associated with the text as the constraint, and a visual representation of the string of characters as feature information to be displayed.

In some embodiment, recreation engine 152 may generate a feature template when a video item is uploaded to platform 120. For example, when the video item is created via the video creation tool, metadata of the video item can be generated. Metadata may include an interval (e.g., a start time and stop time) of each segment of the video item recorded, an identifier and timestamp for each filter, audio, or text applied to/used with the video item, and a location, if applicable, within the video item where the filter, audio, or text is applied/used. Once the video item is created, the video item may be uploaded to data store 110. During upload of the video item, recreation engine 152 may generate a feature template using the metadata of the video item. In particular, recreation engine 152 can identify each feature of the video item using the metadata. Based on each identified feature of the video item, recreation engine 152 can generate the feature template including a feature representation placeholder for each identified feature of the video item. The feature template may be stored in data store 110 with the video item. Alternatively, the feature template may be stored in a separate data store referenced by an identifier of the video item.

In some embodiments, recreation engine 152 may periodically (e.g., hourly, daily, weekly, etc.) generate feature templates for each video item in data store 110. For each video item in data store 110, recreation engine 152 may generate a feature template using metadata of the video item. In some embodiments, a video item in data store 110 may have been externally created (e.g., not using the video creation tool) or lack sufficient metadata to identify features to be used in generating a feature template. As a result, prior to generating the feature template, various methods may be employed to generate metadata for the video item by identifying features of the video item and extracting relevant information associated with the identified features.

For example, a segment detection algorithm that performs shot boundary detection (o find the transitions between the camera shots in a video) may be used to identify segments and characteristics of segments (segment characteristic features) of the video item. Segment detection algorithms can identify segment characteristic features of the video item by calculating a histogram for each frame of the video item. For each window increment (e.g., movement) of a predefined sliding time window across the length of the video item, segment detection algorithm can obtain an average of the calculated histograms for the frames that fall within the predefined sliding time window (e.g., window histogram average). Segment detection algorithm can determine whether a difference between the window histogram average of a previous window increment and the window histogram average of a current window increment exceeds a predetermined threshold value. The comparison with the predetermined threshold value can indicate the presence of a new segment of the video item. Responsive to determining that the difference exceeds the predetermined threshold value, segment detection algorithm can extract a start time and stop time of the new segment of the video item (e.g., metadata for the new segment). Segment detection algorithm can store, with the video item, the resulting metadata associated with the segment characteristic feature. Accordingly, recreation engine 152 can generate the feature template using metadata of the video. As previously described, the feature template may be stored in data store 110 with the video item or in a separate data store referenced by an identifier of the video item.

Although implementations of the disclosure are discussed in terms of recreation engine 152 creating a new video item based on an existing video item, embodiments of the present disclosure can also apply to any types of media items including, for example, audio items, images, etc.

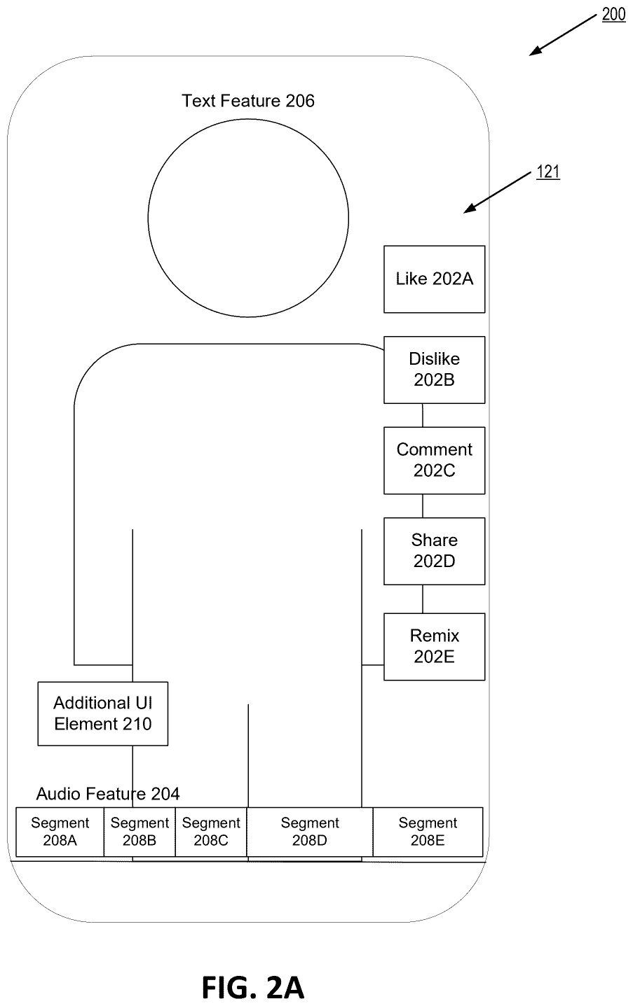

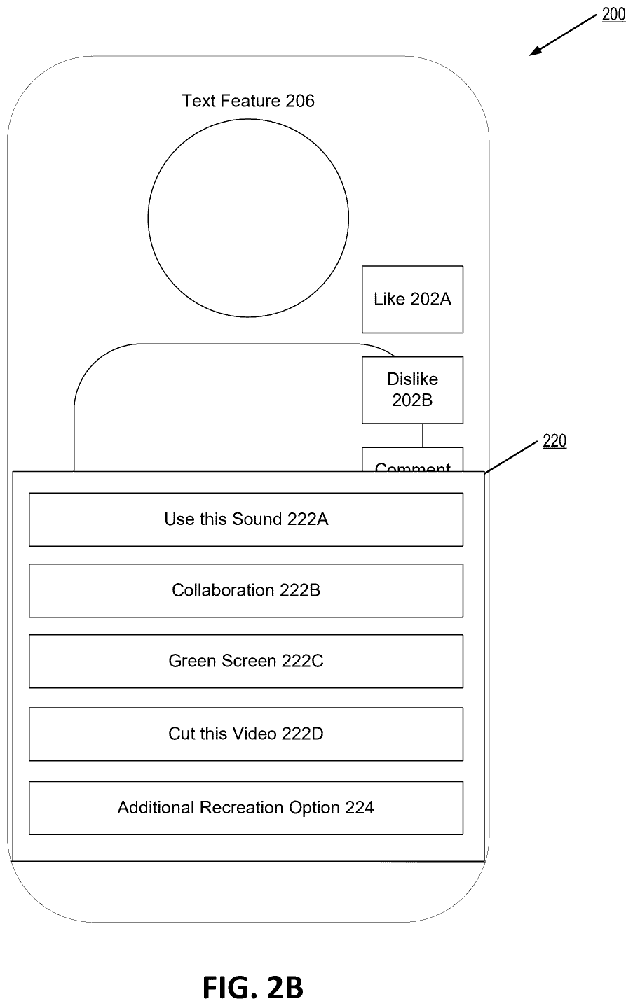

FIG. 2A illustrates an example UI of a content viewer displaying an existing short form video with a UI element triggering a reuse of features of the existing short form video for a new short form video, in accordance with implementations of the present disclosure.

With reference to FIG. 2A, UI 200 of the content viewer displays a video item (e.g., video item 121) and overlays a set of engagement UI elements 202A-E. Video item 121 may include, for example, an audio feature 204, a text feature 206, and one or more segment characteristic features 208A-E. In some embodiments, video item 121 may also include one or more filter features (not shown). The set of engagement UI elements 202A-E may include, for example, a like button (e.g., engagement UI elements 202A), a dislike button (e.g., engagement UI elements 202B), a comment button (e.g., engagement UI elements 202C), a share button (e.g., engagement UI elements 202D), and a remix button (e.g., engagement UI elements 202E). During playback of video item 121 in UI 200 of the content viewer, based on a feature template available for video item 121, an additional UI element 210 may be overlaid over video item 121 in the UI 200 of the content viewer. The additional UI element 210, when selected, can provide a user with an option to utilize the feature template associated with the video item 121 to create a new video item (e.g., the selection of the UI element 210 can cause a remix panel to slide up and present an option to use the feature template of the video item 121 for the new video item). In response to user input selecting the UI element 210, a user request can be sent to recreation engine 152. Recreation engine 152 can retrieve the feature template of the video item 121 and present the feature template in the video creation tool of the client device 102N of the user.

FIG. 2B illustrates an example content viewer UI displaying an existing short form video with UI elements representing features of the existing short form video that can be inherited by a new short form video, in accordance with implementations of the present disclosure.

With reference to FIG. 2B, the selection of an additional UI element (e.g., an additional UI element 210 of FIG. 2A), or of a remix button (e.g., engagement UI elements 202E of FIG. 2A), can cause menu 220 to be presented in UI 200 of the content viewer.

Menu 220 can include a set of recreation option UI elements 222A-D. The set of recreation option UI elements 222A-D can include, for example, “use this sound” button (e.g., recreation option UI elements 222A), “collaboration” button (e.g., recreation option UI elements 222B), “green screen” button (e.g., recreation option UI elements 222C), and “cut this video” button (e.g., recreation option UI elements 222D). “Use this sound” button (e.g., recreation option UI elements 222A) can allow the user to add audio from video item 121 into a new video item. “Collaboration” button (e.g., recreation option UI elements 222B) can allow the user to collaborate with other users to create a new video item from video item 121 (e.g., by responding, reacting, etc. to input of the other users) while being presented with the video item 121 side by side with a new video item. “Green screen” button (e.g., recreation option UI elements 222C) can allow the user to use video item 121 as a background for a new video item. “Cut this video” button (e.g., recreation option UI elements 222D) can allow the user to extract a portion of video item 121 to add to a new video item.

Based on a feature template being available for video item 121, an additional recreation option UI element 224 may be populated in menu 220. The additional recreation option UI element 224 when selected, can provide a user with an option to utilize the feature template associated with the video item (e.g., video item 121) to create a new video item. In response to selecting the recreation option UI element 224, recreation engine 152 can retrieve the feature template of the video item and present the feature template in the video creation tool of the client device 102N of the user.

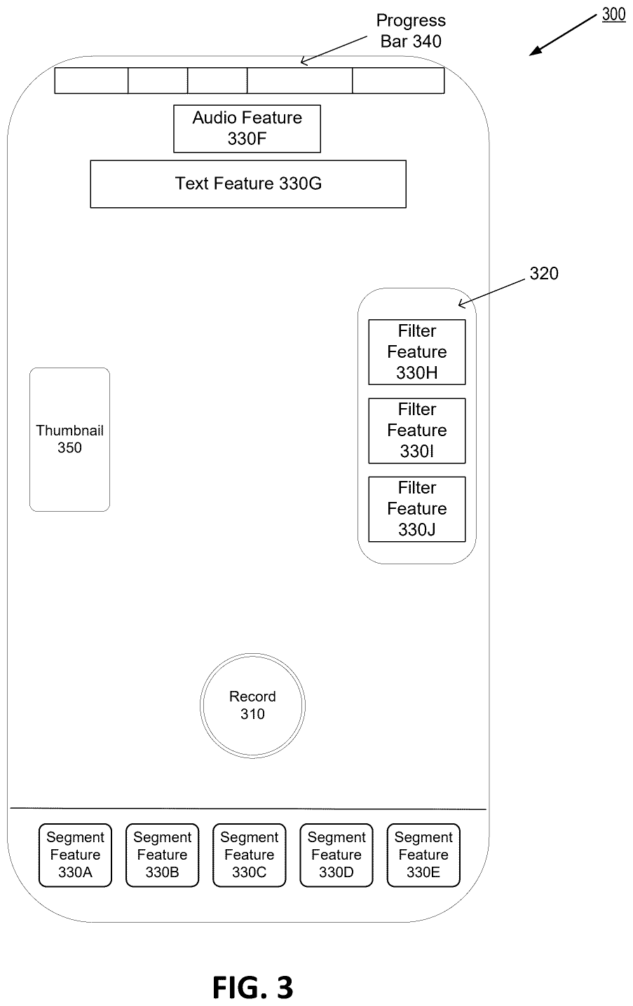

FIG. 3 illustrates an example UI to visually indicate features of an existing short form video that may be inherited by a new short form video, in accordance with implementations of the present disclosure.

With reference to FIG. 3, UI 300 can be a camera UI that includes a record UI element 310 that allows a user to record content using a camera of the client device (e.g., client device 102N). As previously described, video creation tool supports multi-segment camera recording which allows users to record in segments. UI 300 can be presented upon a user selection of the recreation option UI element 224 or any other UI element representing the use of the feature template associated with the video item 121 to create a new video item.

As discussed above, a feature template may include a plurality of feature representation placeholders. During presentation of the feature template, the plurality of feature representation placeholders of the feature template is displayed on UI 300. The plurality of feature representation placeholders may include a set of segment characteristic feature representation placeholders 330A-E, an audio feature representation placeholder 330F, a text feature representation placeholder 330G, and a set of filter feature representation placeholders 330H-J. Each segment characteristic feature representation placeholder of the set of segment characteristic feature representation placeholders 330A-E corresponds to a segment's one or more of the segment characteristic features 208A-E of FIG. 2A, respectively. Audio feature representation placeholder 330F corresponds to audio feature 204 of FIG. 2A. Text feature representation placeholder 330G corresponds to text feature 206 of FIG. 2A. Filter feature representation placeholders 330H-J correspond to one or more filter features of video item 121 (not shown). In some embodiments, a thumbnail 350 of video item 121 is displayed in UI 300 for reference by the user. For each feature representation placeholder of the plurality of feature representation placeholders the recreation engine 152 displays a UI element within UI 300. The UI element is displayed based on designated location of a respective feature representation placeholder. The UI element contains information of the respective feature representation placeholder.

For example, recreation engine 152 displays the set of segment characteristic feature representation placeholders 330A-E, in chronological order, in a lower region of UI 300. Additionally, recreation engine 152 displays, in an upper region of UI 300, a progress bar 340 representing a duration of the video item 121 segmented based on each duration included in the set of segment characteristic feature representation placeholders 330A-E.

Recreation engine 152 displays audio feature representation placeholder 330F in an upper region of the UI 300. In some embodiments, recreation engine 152 may determine, based on audio feature representation placeholder 330F, that the corresponding audio feature of the video item 121 is associated with a specific segment of video item 121. As a result, recreation engine 152 can display audio feature representation placeholder 330F when a corresponding segment characteristic feature representation placeholder (e.g., segment feature representation placeholder 330A) is selected by the user.

Recreation engine 152 displays text feature representation placeholder 330G. In some embodiments, recreation engine 152 may determine, based on text feature representation placeholder 330G, that the corresponding text feature of the video item 121 is associated with a specific segment of video item 121. As a result, recreation engine 152 can display text feature representation placeholder 330G when a corresponding segment characteristic feature representation placeholder (e.g., segment characteristic feature representation placeholder 330A) is selected by the user.

Recreation engine 152 can display, within the filter panel 320 of UI 300, filter feature representation placeholders 330H-J. In some embodiments, recreation engine 152 may determine, based on filter feature representation placeholders 330H-J, that the corresponding filter feature of the video item 121 is associated with a specific segment of video item 121. As a result, recreation engine 152 can display filter feature representation placeholders 330H-J within the filter panel 320 when a corresponding segment characteristic feature representation placeholder (e.g., segment characteristic feature representation placeholder 330A) is selected by the user.

When creating a new video item a user may select a segment characteristic feature representation placeholder (e.g., segment characteristic feature representation placeholder 330A) and may initiate, using the record UI element 310, the recording of a segment to be included in a new video item which may be limited to a duration of a corresponding segment characteristic feature of video item 121. As previously described, the filter panel 320 may include filter feature representation placeholders 330H-J. During and/or after the recording of the segment, filter features associated with the one or more filter feature representation placeholders 330H-J may be applied to the recording of the segment. Additionally, features associated with any feature representation placeholders displayed in the UI 300 (e.g., audio feature representation placeholder and/or text feature representation placeholders) may be applied during and/or after recording of the segment. Once the new video item including segments with features inherited from corresponding segments of video item 121 based on the set of segment characteristic feature representation placeholders 330A-E is created, the new video item may be uploaded to data store 110 to be available to other users.

In some embodiments, the UI 300 presents with new video item with features (e.g., one or more of the text, audio, visual effect, and segment characteristics) inherited from the video item 121. In some embodiments, the UI 300 provides the user with options to change and adjust any of the features that are inherited by the new video item. For example, one or more of the text, audio, visual effect, and segment characteristics of the video item 121 can be modifiable by the user prior to adding those features to the new video item.

In general, functions described in implementations as being performed by platform 120 and/or server machine 150 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing a short form video, implementations can also be generally applied to any video item. Implementations of the disclosure are not limited to recreation of a short form video.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

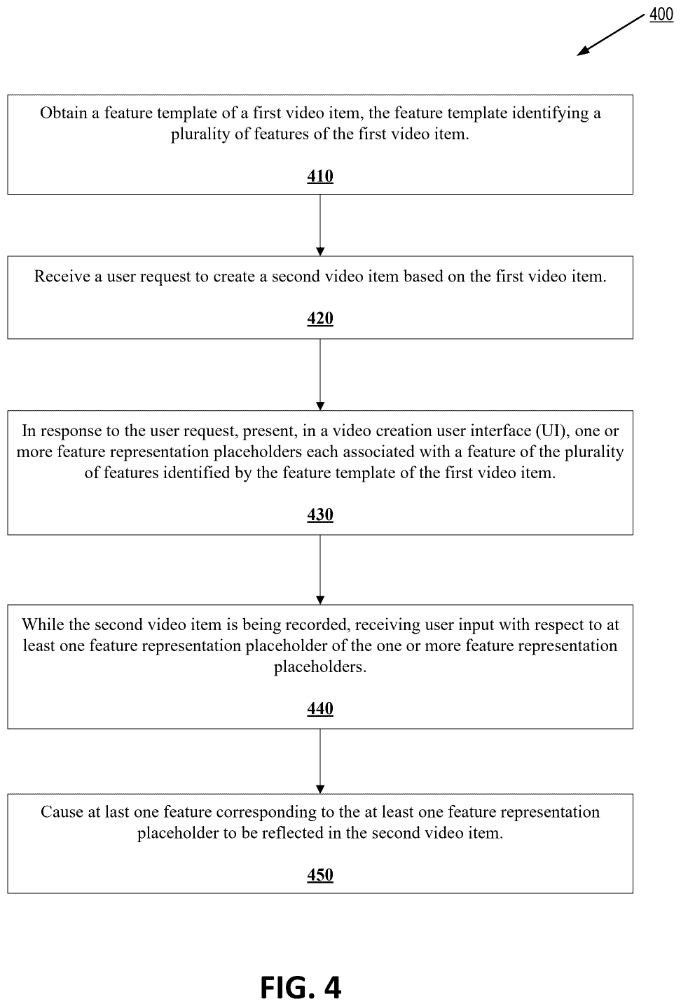

FIG. 4 depicts a flow diagram of an example method 400 for enhancing short form video creation tool of a content platform, in accordance with implementations of the present disclosure. Method 400 can be performed by processing logic that can include hardware (circuitry, dedicated logic, etc.), software (e.g., instructions run on a processing device), or a combination thereof. In one implementation, some, or all of the operations of method 400 can be performed by one or more components of system 100 of FIG. 1. In some embodiments, some, or all of the operations of method 400 can be performed by recreation engine 152 of FIG. 1, as described above.

At block 410, the processing logic obtains a feature template of a first video item, the feature template identifying a plurality of features of the first video item. The plurality of features may include, for example, an audio (e.g., audio feature), a text (e.g., text feature), a video clip characteristic(s) (e.g., segment characteristic feature), or a visual effect (e.g., filter feature). As previously described, a feature template may be generated for the video item in response to upload of the video item or periodic processing of stored video items. The generated feature template associated with the first video item may be stored with the first video item or separately which is identified using an identifier of the first video item. The user can be presented, in a UI of the content viewer, a UI element indicating the availability of a feature template for the first video item.

At block 420, the processing logic receives a user request to create a second video item based on the first video item. As previously described, the user request can be issued in response to a user selection of a dedicated UI element.

At block 430, in response to the user request, the processing logic presents, in a video creation user interface (UI) (e.g., UI of the video creation tool), one or more feature representation placeholders each associated with a feature of the plurality of features identified by the feature template of the first video item. As previously described, each of the one or more feature representation placeholder can be displayed in a corresponding designated location.

Each of the one or more feature representation placeholders can include attributes of a corresponding feature. Attributes can include an identifier of the feature, a constraint of the feature, a designated location for the feature, and information to be displayed about the feature.

Depending on the embodiment, in response to presenting the one or more feature representation placeholders, the processing logic can overlay, in the UI, a thumbnail of the first video item on a portion of the second video item.

At block 440, while the second video item is being recorded, the processing logic receives user input with respect to (e.g., user selection of) at least one of the feature representation placeholders.

At block 450, the processing logic causes at least one feature corresponding to the at least one feature representation placeholder to be reflected in the second video item. In some embodiments, causing at least one feature corresponding to the at least one feature representation placeholder to be reflected in the second video item includes recording, for a duration associated with the at least one feature representation placeholder, a video clip associated with the second video item, and adding the corresponding at least one feature to the recorded video clip.

As previously described, a feature representation placeholder (e.g., a segment characteristic feature representation placeholder) can be selected when a video clip is being recorded. The duration of the video clip may be limited to a duration provided by the feature representation placeholder which corresponds to a duration of a segment characteristic feature of the first video item. Additionally, one or more feature representation placeholders (e.g., filter feature representation placeholders, text feature representation placeholders, and/or audio feature representation placeholders) may identify one or more filter features, text features, and/or audio features of the first video item to be applied to the video clip. For example, the processing logic, during recording the video clip, applies, in real-time, a visual effect (e.g., filter features of the first video item) associated with the respective feature representation placeholder (e.g., filter feature representation placeholder) to the video clip.

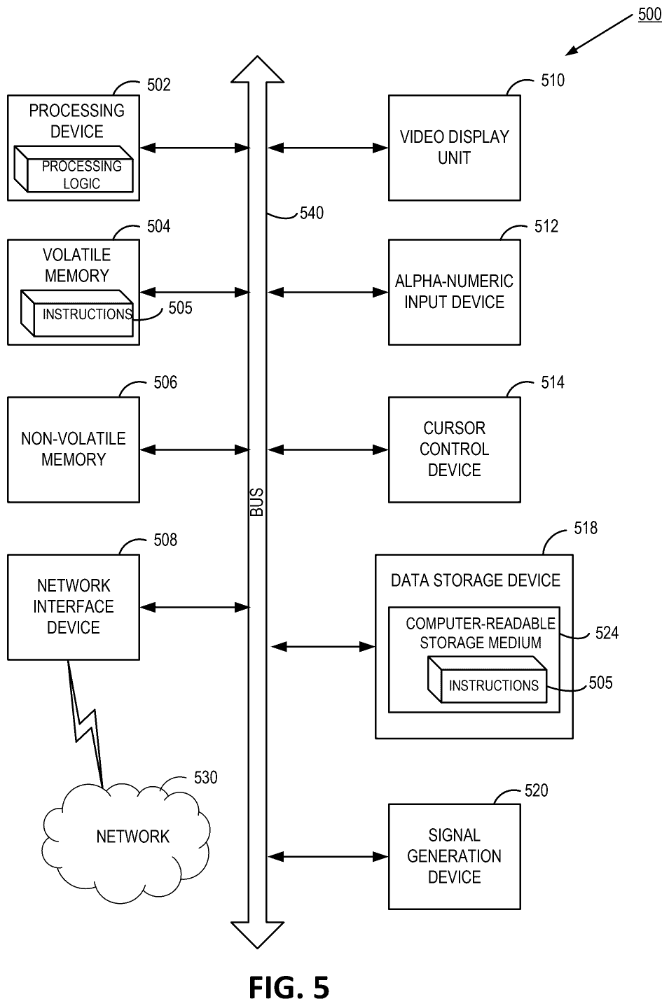

FIG. 5 is a block diagram illustrating an exemplary computer system 500, in accordance with implementations of the present disclosure. The computer system 500 can correspond to platform 120 and/or client devices 102A-N, described with respect to FIG. 1. Computer system 500 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 518, which communicate with each other via a bus 540.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 505 for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 520 (e.g., a speaker).

The data storage device 518 can include a non-transitory computer-readable storage medium 524 (also machine-readable storage medium) on which is stored one or more sets of instructions 505 embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 530 via the network interface device 508.

In one implementation, the instructions 505 include instructions for providing fine-grained version histories of electronic documents at a platform. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
obtaining a feature template of a first video item, the feature template identifying a plurality of features of the first video item;
receiving a user request to create a second video item based on the first video item; and
in response to the user request to create the second video item based on the first video item:
presenting, in a video creation user interface (UI), one or more feature representation placeholders each corresponding to a UI element displaying information about a feature of the plurality of features identified by the feature template of the first video item;
while the second video item is being recorded, receiving user input selecting at least one UI element that is associated with at least one feature representation placeholder of the one or more feature representation placeholders, and that displays information about at least one respective feature identified by the feature template of the first video item; and
in response to the user input selecting at least one UI element, causing at least one feature corresponding to the at least one feature representation placeholder to be reflected in the second video item.

2. The method of claim 1, wherein the plurality of features includes at least one of: an audio of the first video item, a text of the first video item, a segment characteristic of the first video item, or a visual effect of the first video item.

3. The method of claim 1, wherein each of the one or more feature representation placeholders comprises attributes of a corresponding feature.

4. The method of claim 3, wherein the attributes of a feature comprise an identifier of the feature, a constraint of the feature, a designated location for the feature, and information to be displayed about the feature.

5. The method of claim 1, wherein the video creation UI presents a thumbnail of the first video item along with the one or more feature representation placeholders.

6. The method of claim 1, wherein causing at least one feature corresponding to the at least one feature representation placeholder to be reflected in the second video item comprises:
recording, for a duration associated with the at least one feature representation placeholder, a video clip associated with the second video item; and
adding the corresponding at least one feature to the recorded video clip.

7. The method of claim 6, further comprising:
presenting the recorded video clip with the corresponding at least one feature to be inherited from the first video item; and
allowing a user to modify the corresponding at least one feature for the recorded video clip.

8. A system comprising:
a processing device to perform operations comprising:
obtaining a feature template of a first video item, the feature template identifying a plurality of features of the first video item;
obtaining a feature template of a first video item, the feature template identifying a plurality of features of the first video item;
receiving a user request to create a second video item based on the first video item; and
in response to the user request to create the second video item based on the first video item:
presenting, in a video creation user interface (UI), one or more feature representation placeholders each corresponding to a UI element displaying information about a feature of the plurality of features identified by the feature template of the first video item;
while the second video item is being recorded, receiving user input selecting at least one UI element that is associated with at least one feature representation placeholder of the one or more feature representation placeholders, and that displays information about at least one respective feature identified by the feature template of the first video item; and
in response to the user input selecting at least one UI element, causing at least one feature corresponding to the at least one feature representation placeholder to be reflected in the second video item.

9. The system of claim 8, wherein the plurality of features includes at least one of: an audio of the first video item, a text of the first video item, a segment characteristic of the first video item, or a visual effect of the first video item.

10. The system of claim 8, wherein each of the one or more feature representation placeholders comprises attributes of a corresponding feature.

11. The system of claim 10, wherein the attributes of a feature comprise an identifier of the feature, a constraint of the feature, a designated location for the feature, and information to be displayed about the feature.

12. The system of claim 8, wherein the video creation UI presents a thumbnail of the first video item along with the one or more feature representation placeholders.

13. The system of claim 8, wherein causing at least one feature corresponding to the at least one feature representation placeholder to be reflected in the second video item comprises:
recording, for a duration associated with the at least one feature representation placeholder, a video clip associated with the second video item; and
adding the corresponding at least one feature to the recorded video clip.

14. The system of claim 13, further comprising:
presenting the recorded video clip with the corresponding at least one feature to be inherited from the first video item; and
allowing a user to modify the corresponding at least one feature for the recorded video clip.

15. A non-transitory computer-readable medium comprising instructions that, responsive to execution by a processing device, cause the processing device to perform operations comprising:
obtaining a feature template of a first video item, the feature template identifying a plurality of features of the first video item;
receiving a user request to create a second video item based on the first video item; and
in response to the user request to create the second video item based on the first video item:
presenting, in a video creation user interface (UI), one or more feature representation placeholders each corresponding to a UI element displaying information about a feature of the plurality of features identified by the feature template of the first video item;
while the second video item is being recorded, receiving user input selecting at least one UI element that is associated with at least one feature representation placeholder of the one or more feature representation placeholders, and that displays information about at least one respective feature identified by the feature template of the first video item; and
in response to the user input selecting at least one UI element, causing at least one feature corresponding to the at least one feature representation placeholder to be reflected in the second video item.

16. The non-transitory computer-readable medium of claim 15, wherein the plurality of features includes at least one of: an audio of the first video item, a text of the first video item, a segment characteristic of the first video item, or a visual effect of the first video item.

17. The non-transitory computer-readable medium of claim 15, wherein each of the one or more feature representation placeholders comprises attributes of a corresponding feature.

18. The non-transitory computer-readable medium of claim 17, wherein the attributes of a feature comprise an identifier of the feature, a constraint of the feature, a designated location for the feature, and information to be displayed about the feature.

19. The non-transitory computer-readable medium of claim 15, wherein the video creation UI presents a thumbnail of the first video item along with the one or more feature representation placeholders.

20. The non-transitory computer-readable medium of claim 15, wherein causing at least one feature corresponding to the at least one feature representation placeholder to be reflected in the second video item comprises:
recording, for a duration associated with the at least one feature representation placeholder, a video clip associated with the second video item; and
adding the corresponding at least one feature to the recorded video clip.
